(19) United States
(12) Patent Application Publication
(10) Pub. No.: US 2022/0138355 A1
(43) Pub. Date: May 5, 2022

(54) SYSTEMS AND METHODS FOR MODIFYING SECURITY OR PRIVACY MODE OF INFORMATION HANDLING SYSTEM PERIPHERALS

(71) Applicant: Dell Products L.P., Round Rock, TX (US)

(72) Inventors: Daniel L. HAMLIN, Round Rock, TX (US); Vivek Viswanathan IYER, Austin, TX (US)

(73) Assignee: Dell Products L.P., Round Rock, TX (US)

(21) Appl. No.: 17/087,940

(22) Filed: Nov. 3, 2020

(51) Int. Cl. G06F 21/83; G06F 21/60

(52) U.S. Cl. CPC G06F 21/83; G06F 21/604

(57) ABSTRACT

An information handling system may include a processor, a management controller communicatively coupled to the processor for out-of-band management of the information handling system, and configured to monitor for a user action to modify a security or privacy mode of a peripheral associated with the information handling system and responsive to the user action, communicate a vendor-defined message to the peripheral to modify the security or privacy mode.

### TECHNICAL FIELD

The present disclosure relates in general to information handling systems, and more particularly to systems and methods for modifying security or privacy mode of information handling system peripherals.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many instances, it may be desirable to allow a user to quickly modify privacy and security mode of an information handling system based on user and/or on-demand needs using shortcut keys or “hot keys,” for example to include multiple peripheral devices such as a display device, audio input device, video input device, and/or others, and including both devices internal to an information handling system and devices coupled via a docking station.

For example, it may be desirable for a user to trigger a reactive security mode in which a user can quickly blur or minimize sensitive content displayed on display devices. As another example, when coupling to a docking station, a user may desire that his/her information handling system draws power but does not communicate data between the information handling system and docking station. As a further example, a user may desire that his/her information handling system maintains ownership of a connection to a docking station but does not communicate data between the information handling system and docking station.

### SUMMARY

In accordance with the teachings of the present disclosure, the disadvantages and problems associated with enabling activation of a security and/or privacy mode in an information handling system may be reduced or eliminated.

In accordance with embodiments of the present disclosure, an information handling system may include a processor, a management controller communicatively coupled to the processor for out-of-band management of the information handling system, and configured to monitor for a user action to modify a security or privacy mode of a peripheral associated with the information handling system and responsive to the user action, communicate a vendor-defined message to the peripheral to modify the security or privacy mode.

In accordance with these and other embodiments of the present disclosure, a method may include, in a management controller for out-of-band management of an information handling system, monitoring for a user action to modify a security or privacy mode of a peripheral associated with the information handling system and responsive to the user action, communicating a vendor-defined message to the peripheral to modify the security or privacy mode.

In accordance with these and other embodiments of the present disclosure, an article of manufacture may include a computer readable medium and computer-executable instructions carried on the computer readable medium, the instructions readable by a processor, the instructions, when read and executed, for causing the processor to, in a management controller for out-of-band management of an information handling system: monitor for a user action to modify a security or privacy mode of a peripheral associated with the information handling system and responsive to the user action, communicate a vendor-defined message to the peripheral to modify the security or privacy mode.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including an information handling system and a wireless docking station, in accordance with certain embodiments of the present disclosure; and

FIG. 2 illustrates a flow chart of an example method for modifying a security or privacy mode of information handling system peripherals, in accordance with certain embodiments of the present disclosure.

### DETAILED DESCRIPTION

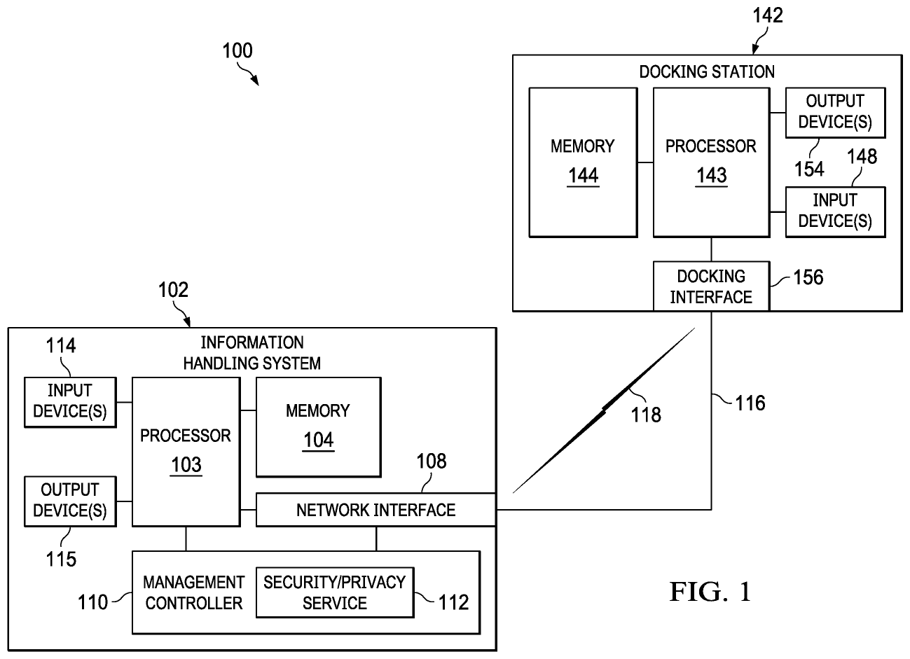

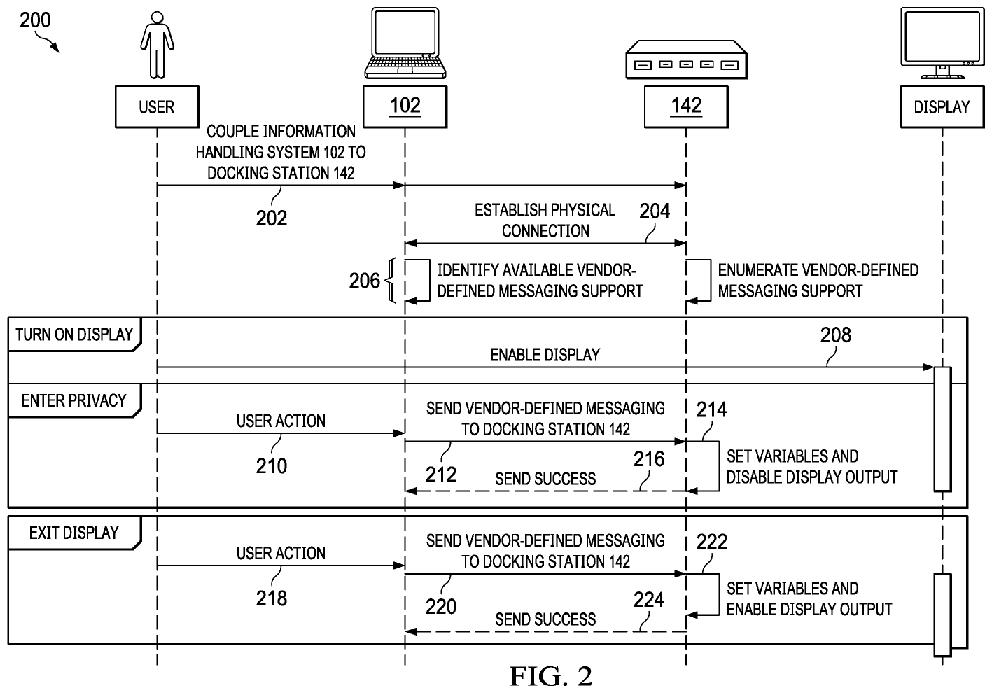

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

The terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), IEEE 802.11ad (Wireless Gigabit or “WiGig”), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, etc.

FIG. 1 illustrates a block diagram of an example system 100 including an information handling system 102 and a wireless docking station 142, in accordance with certain embodiments of the present disclosure.

In some embodiments, information handling system 102 may be a personal computer. In particular embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a network interface 108 communicatively coupled to processor 103, a management controller 110 communicatively coupled to processor 103 and network interface 108, one or more input devices 114 communicatively coupled to processor 103, and one or more output devices 115 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage resource, and/or another component of information handling system 102.

Memory 104 may include any system, device, or apparatus configured to retain data (including program instructions) for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Network interface 108 may comprise any suitable system, apparatus, or device operable to serve as an interface between information handling system 102 and another information handling system and/or a network. Network interface 108 may enable information handling system 102 to communicate using any suitable transmission protocol and/or standard. In some embodiments, network interface 108 may be configured to communicate with docking interface 156 of docking station 142 via wire-line transmissions 116. In these or other embodiments, network interface 108 may be configured to communicate with docking interface 156 of docking station 142 via wireless transmissions 118. In these and other embodiments, network interface 108 may comprise a network interface card, or “NIC.”

Management controller 110 may be configured to provide management facilities for management of information handling system 102. Such management may be made by management controller 110 even if information handling system 102 is powered off or powered to a standby state. Management controller 110 may include a processor, a memory, and or other components. In certain embodiments, management controller 110 may include or may be an integral part of an embedded controller (EC), baseboard management controller (BMC), or a remote access controller (e.g., a Dell Remote Access Controller or Integrated Dell Remote Access Controller).

As shown in FIG. 1, management controller 110 may implement a security/privacy service 112. In some embodiments, security/privacy service 112 may include a software service or firmware service of management controller 110 configured to, when read and executed by a processor of management controller 110, perform the functionality of security/privacy service 112 as described herein. Security/privacy service 112 may be configured to receive a trigger key sequence from a keyboard (e.g., keyboard of input device(s) 114 or keyboard of input device(s) 148) or other input device associated with information handling system 102, and responsive to such trigger key sequence, communicate a secured command to one or more peripheral devices (e.g., input device(s) 114, output device(s) 115, input device(s) 148, output device(s) 154) to modify a security or privacy mode of such one or more peripheral devices in a secure and protected manner.

Further, in operation, upon physical coupling of a docking station 142 or another device (e.g., a Universal Serial Bus Type-C device), management controller 110 may discover vendor-defined messaging capabilities of the device. Upon determination of known device and vendor-defined messaging capabilities for a security operation of the device, management controller 110 may enable security/privacy service 112 to execute security or privacy operations.

Once enabled to execute security or privacy operations, security/privacy service 112 may monitor for a user interaction for triggering a security or privacy operation, such as a user entering a predefined keystroke sequence on a keyboard communicatively coupled to information handling system 102 or docking station 142. Upon receipt of such user interaction, security/privacy service 112 may communicate a customized vendor-defined message to a peripheral device to perform a security/privacy action. In response to receiving the vendor-defined message, the peripheral device may modify its behavior accordingly. For example, if the peripheral device is a display device, the peripheral device may blur or turn off its display. As another example, if the peripheral device is docking station 142, docking station 142 may disable data communication while allowing information handling system 102 to continue drawing power from docking station 142. Upon receipt of a subsequent vendor-defined message to cease the security/privacy action, the peripheral device may modify its behavior appropriately (e.g., un-blur or turn on display, allow data communication between information handling system 102 and docking station 142).

Input device(s) 114 may comprise any system, device, or apparatus configured to receive user input or an indication of user input. For example, input device(s) 114 may include a power button, keyboard, mouse, microphone, and/or other suitable input device.

Output device(s) 115 may comprise any system, device, or apparatus configured to output information in the form of visual information, audible information, printed information, and/or other suitable manner. For example, output device(s) 115 may include a display device, an audio transducer (e.g. speaker or headphone), a printer, and/or other suitable output device.

In addition to processor 103, memory 104, network interface 108, management controller 110, input device(s) 114, and/or output device(s) 115, information handling system 102 may include one or more other information handling resources.

Docking station 142 may comprise a docking station, port replicator, or dock that allows information handling system 102 or another electronic device to communicatively couple to information handling resources (e.g., keyboard, monitor, mouse, external storage resources, network interfaces, etc.) attached to or integral to docking station 142. Docking station 142 may allow information handling system 102 to communicatively couple to docking station 142 (and thus the devices communicatively coupled to docking station 142) via wire-line transmissions 116 and/or wireless transmissions 118 communicated between network interface 108 and docking interface 156. In some embodiments, docking station 142 may comprise an information handling system, albeit with functionality and/or structure different than that of information handling system 102. As depicted in FIG. 1, docking station 142 may include a processor 143, a memory 144 communicatively coupled to processor 143, one or more input devices 148 communicatively coupled to processor 143, one or more output devices 154 communicatively coupled to processor 143, and a docking interface 156 communicatively coupled to processor 143.

Processor 143 may include any system, device, or apparatus configured to interpret and/or execute program instructions and/or process data, and may include, without limitation, a microprocessor, microcontroller, DSP, ASIC, or any other digital or analog circuitry configured to interpret and/or execute program instructions and/or process data. In some embodiments, processor 143 may interpret and/or execute program instructions and/or process data stored in memory 144 and/or another component of docking station 142.

Memory 144 may be communicatively coupled to processor 143 and may include any system, device, or apparatus configured to retain program instructions and/or data for a period of time (e.g., computer-readable media). Memory 144 may include RAM, EEPROM, a PCMCIA card, flash memory, magnetic storage, opto-magnetic storage, or any suitable selection and/or array of volatile or non-volatile memory that retains data after power to docking station 142 is turned off. Memory 144 may be either internal or external to docking station 142.

Input devices 148 may comprise any system, device, or apparatus configured to receive user input or an indication of user input. For example, input devices 148 may include a power button, keyboard, mouse, microphone, and/or other suitable input device.

Output devices 154 may comprise any system, device, or apparatus configured to output information in the form of visual information, audible information, printed information, and/or other suitable manner. For example, output devices 154 may include a display device, an audio transducer (e.g. speaker or headphone), a printer, and/or other suitable output device.

Docking interface 156 may comprise any suitable system, apparatus, or device operable to serve as a communications interface between docking station 142 and network interface 108 of information handling system 102. Docking interface 156 may be configured to communicate with network interface 108 of information handling system 102 via wire-line transmissions 116 and/or wireless transmissions 118.

In addition to processor 143, memory 144, and docking interface 156, docking station 142 may include one or more other information handling resources.

FIG. 2 illustrates a flow chart of an example method 200 for modifying a security or privacy mode of information handling system peripherals, in accordance with certain embodiments of the present disclosure. According to one embodiment, method 200 may begin at step 202. As noted above, teachings of the present disclosure may be implemented in a variety of configurations of system 100. As such, the preferred initialization point for method 200 and the order of the steps comprising method 200 may depend on the implementation chosen.

Method 200 considers an example of modifying a security or privacy mode of a display device, but it is understood that methods similar to method 200 may be used for modifying a security or privacy mode of any suitable device, in accordance with this disclosure.

At step 202, a user may communicatively couple docking station 142 to information handling system 102. At step 204, docking station 142 and information handling system 102 may establish a physical connection.

At step 206, information handling system 102 may identify its available vendor-defined messaging support and docking station 142 may enumerate its vendor-defined messaging support.

At step 208, the user may turn on a display device coupled to docking station 142.

At step 210, a user may perform an action to indicate a desire to place the display device in a security or privacy mode. In some embodiments, such action may include pressing a predefined key sequence on a keyboard communicatively coupled to information handling system 102 or docking station 142.

At step 212, in response to the user action, security/privacy service 112 may communicate an appropriate vendor-defined message to docking station 142. At step 214, in response to the vendor-defined message, docking station 142 may set appropriate variables and disable or otherwise modify a display output. At step 216, docking station 142 may communicate an indication that docking station 142 successfully placed the display into the security or privacy mode.

At step 218, a user may perform an action to indicate a desire to take the display device out of the security or privacy mode. In some embodiments, such action may include pressing a predefined key sequence on a keyboard communicatively coupled to information handling system 102 or docking station 142.

At step 220, in response to the user action, security/privacy service 112 may communicate an appropriate vendor-defined message to docking station 142. At step 222, in response to the vendor-defined message, docking station 142 may set appropriate variables and enable or otherwise modify a display output. At step 224, docking station 142 may communicate an indication that docking station 142 successfully placed the display into the security or privacy mode.

Steps 210 through 224 may be repeated as necessary.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a management controller communicatively coupled to the processor for out-of-band management of the information handling system, and configured to:
monitor for a user action to modify a security or privacy mode of a peripheral associated with the information handling system; and
responsive to the user action, communicate a vendor-defined message to the peripheral to modify the security or privacy mode.

2. The information handling system of claim 1, wherein the peripheral is communicatively coupled to the information handling system via a docking station.

3. The information handling system of claim 2, the management controller further configured to, in response to coupling of the docking station to the information handling system, identify available vendor-defined messaging support of the management controller for the docking station.

4. The information handling system of claim 1, wherein the user action comprises typing of a predefined keystroke sequence on a keyboard associated with the information handling system.

5. The information handling system of claim 1, wherein the peripheral comprises a display device, and modifying the security or privacy mode comprises modifying viewability of a display of the display device.

6. The information handling system of claim 1, wherein the peripheral comprises a docking station, and modifying the security or privacy mode comprises selectively enabling and disabling data communication capability of the docking station while maintaining an ability of the information handling system to draw power from the docking station.

7. A method comprising, in a management controller for out-of-band management of an information handling system:
monitoring for a user action to modify a security or privacy mode of a peripheral associated with the information handling system; and
responsive to the user action, communicating a vendor-defined message to the peripheral to modify the security or privacy mode.

8. The method of claim 7, wherein the peripheral is communicatively coupled to the information handling system via a docking station.

9. The method of claim 8, further comprising, in response to coupling of the docking station to the information handling system, identifying available vendor-defined messaging support of the management controller for the docking station.

10. The method of claim 7, wherein the user action comprises typing of a predefined keystroke sequence on a keyboard associated with the information handling system.

11. The method of claim 7, wherein the peripheral comprises a display device, and modifying the security or privacy mode comprises modifying viewability of a display of the display device.

12. The method of claim 7, wherein the peripheral comprises a docking station, and modifying the security or privacy mode comprises selectively enabling and disabling data communication capability of the docking station while maintaining an ability of the information handling system to draw power from the docking station.

13. An article of manufacture comprising:
a computer readable medium; and
computer-executable instructions carried on the computer readable medium, the instructions readable by a processor, the instructions, when read and executed, for causing the processor to, in a management controller for out-of-band management of an information handling system:
monitor for a user action to modify a security or privacy mode of a peripheral associated with the information handling system; and
responsive to the user action, communicate a vendor-defined message to the peripheral to modify the security or privacy mode.

14. The article of claim 13, wherein the peripheral is communicatively coupled to the information handling system via a docking station.

15. The article of claim 14, the instructions for further causing the processor to, in response to coupling of the docking station to the information handling system, identify available vendor-defined messaging support of the management controller for the docking station.

16. The article of claim 13, wherein the user action comprises typing of a predefined keystroke sequence on a keyboard associated with the information handling system.

17. The article of claim 13, wherein the peripheral comprises a display device, and modifying the security or privacy mode comprises modifying viewability of a display of the display device.

18. The article of claim 13, wherein the peripheral comprises a docking station, and modifying the security or privacy mode comprises selectively enabling and disabling data communication capability of the docking station while maintaining an ability of the information handling system to draw power from the docking station.
